(19) United States
(12) Patent Application Publication
(10) Pub. No.: US 2018/0238148 A1
(43) Pub. Date: Aug. 23, 2018

(54) Method For Computing Lithofacies Probability Using Lithology Proximity Models

(71) Applicant: Halliburton Energy Services, Inc, Houston, TX (US)

(72) Inventors: Wyatt Jackson Canady, Katy, TX (US); James M. Witkowsky, Houston, TX (US)

(21) Appl. No.: 15/514,345

(22) PCT Filed: Nov. 11, 2015
(86) PCT No.: PCT/US15/60188

§ 371 Date: Mar. 24, 2017

(51) Int. Cl. E21B 41/00; G01V 11/00; G01V 99/00; G06F 17/10

(52) U.S. Cl. CPC E21B 41/0092; G01V 11/002; G01V 2210/665; G06F 17/10; G01V 99/005

(57) ABSTRACT

Methods and systems are presented in this disclosure for computing lithofacies probabilities by using lithology proximity models. Log data related to a plurality of depths of a formation penetrated by a wellbore can be first gathered. Then, for each depth of the formation, distance measures of the log data relative to lithofacies responses of the lithology proximity models can be obtained. The distance measures can be mapped into probability values, and a probability that the particular formation depth belongs to a specific lithofacies can be computed by combining the probability values. The probabilities that various formation depths belong to the lithofacies from the set of lithofacies represent lithofacies earth model of the wellbore, which can be utilized for variety of operations related to the wellbore.

### TECHNICAL FIELD

The present disclosure generally relates to the geological study of earth formations for the location and exploitation of mineral and hydrocarbon deposits using lithofacies analysis and, more particularly, to a method for computing lithofacies probabilities using lithology proximity models and statistical analysis.

### BACKGROUND

Mineral and hydrocarbon prospecting is based upon the geological study and observation of formations of the earth's crust. Correlations have long been established between geological phenomena and the formation of mineral and hydrocarbon deposits that are sufficiently dense to make their exploitation economically profitable.

The study of rock and soil facies encountered while prospecting for minerals and hydrocarbons takes on particular importance. As used herein, a facies is an assemblage of characteristics that distinguish a rock or stratified body from others. A facies results from the physical, chemical and biological conditions involved in the formation of a rock that distinguish it from other rocks or soil. This set of characteristics provides information on the origin of the deposits, their distribution channels and the environment within which they were produced. For example, sedimentary deposits can be classified according to their location (e.g., continental, shoreline or marine, etc.), according to their origin (e.g., fluviatile, lacustrine, eolian, etc.) and according to the environment within which they occurred (e.g., estuaries, deltas, marshes, etc.). This information in turn makes it possible to detect, for example, zones in which the probability of hydrocarbon accumulation is high.

Lithofacies is a mappable subdivision of a designated stratigraphic unit, distinguished from adjacent subdivisions on the basis of lithology, i.e., a facies characterized by particular lithologic features. For example, a lithofacies may be defined by the rock's petrographic and petrophysical characteristics, such as the composition, texture and structure of the rock. Examples of mineral composition are silicate, carbonate, evaporite, and the like. A rock's texture is determined by its grain size, sorting, morphology, degree of compaction, and degree of cementation. The rock structure includes the thickness of beds, their alternation, presence of stones, lenses, fractures, degree of parallelism of laminations, and the like. All of these parameters are related to the macroscopic appearance of the rock.

For extraction of hydrocarbons from geological formations, the particularly pertinent characteristics of the lithofacies are the porosity of the reservoir rocks and their permeability, as well as the fraction of the pore volume occupied by these hydrocarbons. These characteristics can aid in estimating the nature, quantity, and producibility of the hydrocarbons contained in such strata.

There are various sources of information on formation lithofacies. Information may be gathered from subsurface observations such as, for example, by the study of core samples taken from rock formations during the drilling of a wellbore for an oil well. Such information can also be provided by drill cuttings sent up to the surface from the bottom of a well by means of a fluid (e.g., drilling mud) injected near the drilling tool. It is not normally cost-effective to identify lithofacies using these methods. Information on geological formations traversed by a wellbore is more commonly gathered by a measurement sonde passing through the wellbore. The gathered information as a function of the sonde's position along the wellbore is then stored or “logged”. Information on geological formations traversed by a wellbore can be also gathered by Logging While Drilling (LWD) tools and/or Measurement While Drilling (MWD) tools utilized during the drilling of the wellbore. In general, the lithology of a rock unit is a description of its physical characteristics visible at outcrop, in hand or core samples or with low magnification microscopy, such as color, texture, grain size, or composition. In the context of well logs obtained by utilizing sonde, LWD and/or MWD tools, lithology relates to the apparent rock type as determined from the data recorded during the well logging and/or measurement processes.

Various downhole measurement techniques have been used in the past, including passive measurements such as measuring the natural emission of gamma rays; and active measurements such as emitting some form of energy into the formation and measuring the response. Common active measurements include using acoustic waves, electromagnetic waves, electrical currents, and nuclear particles. The sonde measurements are designed to reflect the distinguishing characteristics of the rock facies. Multiple logging tools and sondes may be used to gather the measurements, which are then correlated and standardized to furnish measurements at discrete levels separated by equal depth intervals. The measurement standardization allows the automation of data interpretation in order to obtain estimates of the rock mineral composition, the porosity of the rocks encountered, the pore size distribution, texture and structure, the pore volume occupied by hydrocarbons, and the ease of flow of hydrocarbons out of the reservoirs in the case of petroleum prospecting.

Prior art methods for identifying and mapping formation lithology have employed either deterministic methods based on various crossplot methods or error-minimization methods of logging tool response equations. These methods are mainly focused on mineralogy and rock type determination, with the objective of defining critical reservoir properties such as porosity, saturation, permeability, and the like. However, these methods are often time consuming and require a user to have an extensive prior knowledge about the formations and mineralogy encountered.

Therefore, it is desirable to develop a more efficient method for determining lithofacies and building a lithofacies subterranean earth model.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1 is a schematic diagram showing a cross-sectional view of an illustrative Logging While Drilling (LWD) environment in which a logging tool is deployed, according to certain embodiments of the present disclosure.

FIG. 2 is a schematic diagram showing logging equipment in operation within a wellbore, according to certain embodiments of the present disclosure.

FIG. 3 is a graph illustrating measuring distances of log data from lithofacies responses on a crossplot of log variables, according to certain embodiments of the present disclosure.

FIG. 4 is a graph showing samples of log data being plotted against a limestone lithofacies response (e.g., limestone lithology function) on a neutron-density crossplot, according to certain embodiments of the present disclosure.

FIG. 5 is a graph of a proximity probability function associated with a lithofacies response, according to certain embodiments of the present disclosure.

FIG. 6 is a block diagram of a lithofacies probability determination system, according to certain embodiments of the present disclosure.

FIG. 7 is a graph showing samples of log data being plotted against a dolomite lithofacies response (e.g., dolomite lithology point) on a litho-porosity (M-N) crossplot, according to certain embodiments of the present disclosure.

FIG. 8 is a graph showing examples of neutron-density crossplot probabilities and M-N crossplot probabilities as computed by the system illustrated in FIG. 6, according to certain embodiments of the present disclosure.

FIG. 9 is a flow chart of a method for preparing a library of lithology proximity models (e.g., represented as lithofacies responses such as lithology functions and/or lithology points on crossplots of different subsets of log variables) used by the system illustrated in FIG. 6, according to certain embodiments of the present disclosure.

FIG. 10 is a flow chart of a method for computing lithofacies probabilities using lithology proximity models, according to certain embodiments of the present disclosure.

FIG. 11 is a block diagram of an illustrative computer system in which embodiments of the present disclosure may be implemented.

### DETAILED DESCRIPTION

Embodiments of the present disclosure relate to a method and system for computing lithofacies probabilities using lithology proximity models (e.g., crossplot proximity) and probabilistic analysis, such as combining individual crossplot probabilities into a final lithofacies probability based on Bayesian analysis, probability weighting, and/or neural network processing. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described. It would also be apparent to one ordinarily skilled in the relevant art that the embodiments, as described herein, can be implemented in many different embodiments of software, hardware, firmware, and/or the entities illustrated in the Figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

The disclosure may repeat reference numerals and/or letters in the various examples or Figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding Figure and the downward direction being toward the bottom of the corresponding Figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the Figures. For example, if an apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a Figure may depict a horizontal wellbore or a vertical wellbore, unless indicated otherwise, it should be understood by those ordinarily skilled in the art that the apparatus according to the present disclosure is equally well suited for use in wellbores having other orientations including vertical wellbores, slanted wellbores, multilateral wellbores or the like. Likewise, unless otherwise noted, even though a Figure may depict an offshore operation, it should be understood by those ordinarily skilled in the art that the apparatus according to the present disclosure is equally well suited for use in onshore operations and vice-versa. Further, unless otherwise noted, even though a Figure may depict a cased hole, it should be understood by those ordinarily skilled in the art that the apparatus according to the present disclosure is equally well suited for use in open hole operations.

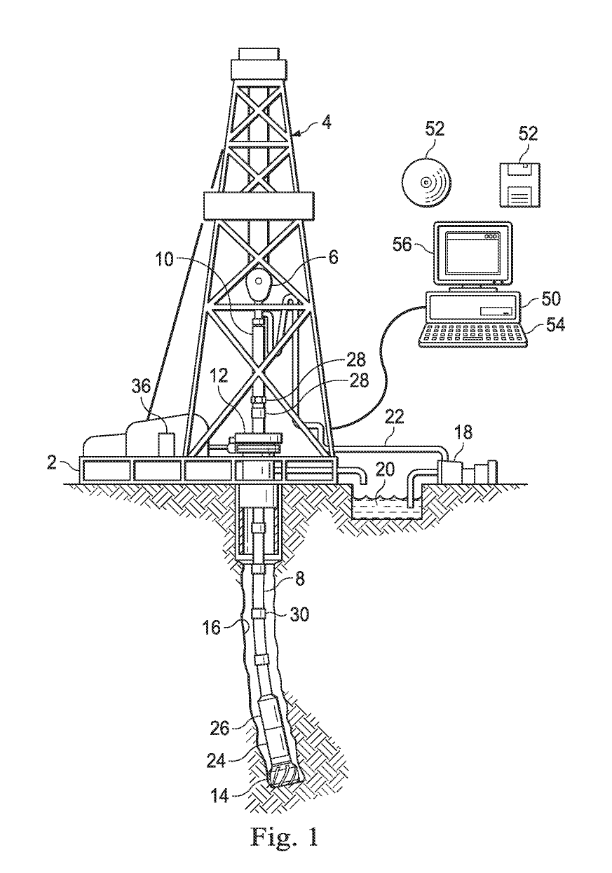

Illustrative embodiments and related methods of the present disclosure are described below in reference to FIGS. 1-11 as they might be employed for computing lithofacies probabilities using lithology proximity models (e.g., crossplot proximity) and probabilistic analysis, such as combining individual crossplot probabilities into a final lithofacies probability based on Bayesian analysis, probability weighting, and/or neural network processing. Such embodiments and related methods may be practiced, for example, using a computer system as described herein. Other features and advantages of the disclosed embodiments will be or will become apparent to one of ordinary skill in the art upon examination of the following Figures and detailed description. It is intended that all such additional features and advantages be included within the scope of the disclosed embodiments. Further, the illustrated Figures are only exemplary and are not intended to assert or imply any limitation with regard to the environment, architecture, design, or process in which different embodiments may be implemented.

The purpose of the present disclosure is to build a lithofacies subterranean earth model from user-supplied information and standard Logging While Drilling (LWD) and/or wireline collected petrophysical data. Embodiments of the present disclosure relate to building the lithofacies subterranean earth model based on a method of defining lithofacies probabilities from the proximity (e.g., nearness) of measured log data responses to known lithological response clusters in the log data.

FIG. 1 shows an illustrative LWD environment in which a logging tool is deployed. A drilling platform 2 supports a derrick 4 having a traveling block 6 for raising and lowering a drill string 8. A top drive 10 supports and rotates drill string 8 as it is lowered through wellhead 12. A drill bit 14 is driven by a downhole motor and/or rotation of drill string 8. As bit 14 rotates, it creates a wellbore 16 that passes through various formations. A pump 18 circulates drilling fluid 20 through a feed pipe 22, through the interior of drill string 8 to drill bit 14. The fluid exits through orifices in drill bit 14 and flows upward through the annulus around drill string 8 to transport drill cuttings to the surface, where the fluid is filtered and recirculated.

Drill bit 14 is just one piece of a bottom-hole assembly that includes one or more drill collars (thick-walled steel pipe) to provide weight and rigidity to aid the drilling process. Some of these drill collars include built-in logging instruments to gather measurements of various drilling parameters such as position, orientation, weight-on-bit, wellbore diameter, etc. The tool orientation may be specified in terms of a tool face angle (rotational orientation), an inclination angle (the slope), and compass direction, each of which can be derived from measurements by magnetometers, inclinometers, and/or accelerometers, though other sensor types such as gyroscopes may alternatively be used. In one specific embodiment, the tool includes a 3-axis fluxgate magnetometer and a 3-axis accelerometer. The combination of those two sensor systems enables the measurement of the tool face angle, inclination angle, and compass direction. Such orientation measurements can be combined with gyroscopic or inertial measurements to accurately track tool position.

An LWD logging tool 24 is integrated into the bottom-hole assembly near bit 14. As bit 14 extends the wellbore through the formations, logging tool 24 rotates and collects azimuthally-dependent reflection measurements that a downhole controller associates with tool position and orientation measurements. The measurements can be stored in internal memory and/or communicated to the surface. A telemetry sub 26 may be included in the bottom-hole assembly to maintain a communications link with the surface. Mud pulse telemetry is one common telemetry technique for transferring tool measurements to surface receivers and receiving commands from the surface, but other telemetry techniques can also be used.

At the surface, a data acquisition module 36 receives the uplink signal from the telemetry sub 26. Module 36 optionally provides some preliminary processing and digitizes the signal. A data processing system 50 (shown in FIG. 1 as a computer) receives a digital telemetry signal, demodulates the signal, and displays the tool data or well logs to a user. Software (represented in FIG. 1 as information storage media 52) governs the operation of system 50. A user interacts with system 50 and its software 52 via one or more input devices 54 and one or more output devices 56.

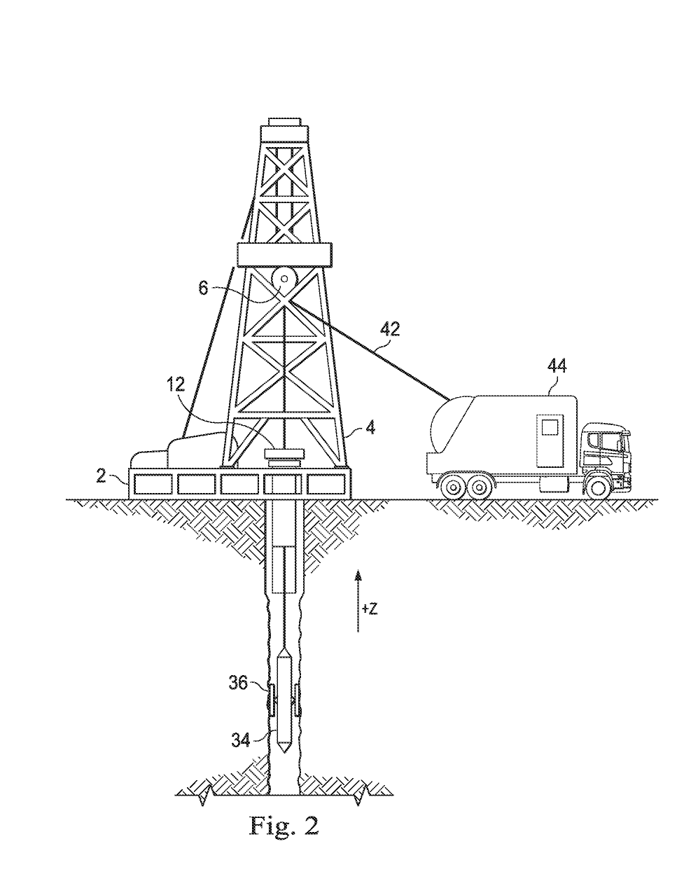

At various times during the drilling process, drill string 8 may be removed from the wellbore as indicated in FIG. 2, which shows an embodiment of the present disclosure deployed in a wireline application. In such an embodiment, once drill string 8 has been removed, logging operations can be conducted using a wireline logging tool 34, i.e., a sensing instrument sonde suspended by a cable 42 having conductors for transporting power to the tool and telemetry from the tool to the surface. In this example, a dielectric logging portion of the logging tool 34 may have sensing pads 36, having one or more electromagnetic sensors positioned thereon, that slide along the wellbore wall as the tool is pulled uphole. A logging facility 44 collects measurements from logging tool 34, and includes computing facilities for processing and storing the measurements gathered by logging tool 34.

The wellbore 16 passes through a series of earth formations (not specifically shown) that is typically composed of a series of zones or “beds”. The zones are identified by the rock facies they contain, e.g., clay, limestone, salt, and so on. From the geological viewpoint, each of these successive zones is characterized by a relative homogeneity that is revealed by a set of characteristic data values (facies). These values vary from one zone to another, but have a relatively limited range of variation within a given zone. These data, which depend in particular on the mineralogical composition, the texture and the structure of the rocks making up these zones, may identify respective facies.

It is possible to establish a correspondence between, on the one hand, different facies characterized by mineralogical factors, texture and structure and, on the other hand, lithofacies that can be obtained directly from a suitable quantitative analysis of a set of logs measured by sonde 34 as it traverses wellbore 16 and/or by LWD logging tool 24 that drills wellbore 16. The possibility of establishing such a correspondence between lithofacies and facies is capable of providing a valuable aid in the geological knowledge of a zone of the earth's crust within a given region, such knowledge being useful in completing the information usually available to geologists and, in certain cases, helping them in the interpretation of the facies encountered to obtain information on the history of the formations and for determining the concentrations of mineral and hydrocarbon deposits.

In accordance with illustrative embodiments of the present disclosure, knowledge of the lithology (lithofacies) related to a drilled wellbore can assist the production of hydrocarbons in several ways. In one or more embodiments, during the drilling process, knowing the lithology at the drill bit face allows drilling professionals to judge the progress of the drilling process, identify issues that might threaten the drilling process and identify target formations when reached. In one or more other embodiments, during directional drilling, the ability to judge lithology at the drill bit face assists in the control of the direction of the drilling process. In one or more other embodiments, in the post drilling assessment of the collected log data, knowledge of the lithology assists the analyst in evaluating the quality of the recorded data, assists in identifying formation tops, aids in the selection of parameters needed in the evaluation of reservoir properties and assists in computation of hydrocarbon reserves.

The illustrative methods presented in this disclosure allow for lithofacies determination based on probabilistic analysis of log data, using one-dimensional (1D), two-dimensional (2D) and/or three-dimensional (3D) crossplot proximity (1D, 2D, and/or 3D lithology proximity models) and probabilistic analysis, such as combining individual crossplot probabilities into final lithofacies probabilities based on Bayesian analysis, probability weighting, and/or neural network processing. The method presented herein can identify any number of lithofacies, as long as each lithofacies provides identifiable pattern(s) on one or more crossplots of log variables. In one or more embodiments, the identifiable pattern(s) can be either of a single point nature (e.g., lithology point) or functional relationship (e.g., 2D or 3D lithology function). The method presented in this disclosure further allows for input of prior knowledge of lithofacies by geologists, petrophysicists, log analysts, and the like. In addition, the method presented herein can accommodate any number of correlations.

The illustrative methods presented in this disclosure are based on the determination of the coordinate distance of datum points (e.g., log values) to recognizable features (e.g., lithology points and/or lithology functions) on 1D, 2D and/or 3D dimension crossplots of log variables. Distances of log values can be plotted against either lithology points or lithology functions. The crossplots of log variables are coded in the present disclosure such that a vertical scale of different shapes represents distance of log values to a desired lithology point or lithology function.

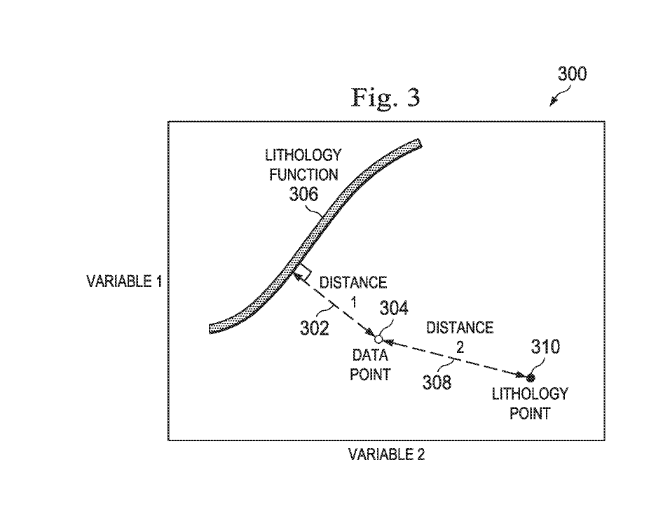

FIG. 3 illustrates a graph 300 showing measurements of distances of log values (e.g., data points) from lithofacies responses on a crossplot of log variables, according to certain illustrative embodiments of the present disclosure. For some embodiments, as illustrated in FIG. 3, a first distance 302 can be measured from a log data point 304 (e.g., a log value related to a pair of log variables) to a pre-determined lithology function (lithofacies response) 306. Then, based on the first measured distance 302, a probability that the log data point 304 corresponds to a lithofacies characterized by the lithology function (lithofacies response) 306 may be obtained. In an embodiment, as discussed in more detail below, the obtained probability may be inverse proportional to the first measured distance 302, i.e., if the first measured distance 302 is smaller, then the obtained probability may be larger since it is more probable that the log data point 304 corresponds to the lithofaces characterized by the lithology function 306. As further illustrated in FIG. 3, a second distance 308 can be measured from the log data point 304 to a known lithology point (lithofacies response) 310 on the crossplot 300 of the pair of log variables, the lithology point 310 characterizing some other lithofacies different from the lithofacies characterized by the lithology function 306. Then, based on the second measured distance 308, another probability that the same log data point 304 corresponds to other lithofacies characterized by the lithology point 310 may be obtained, the other probability being inverse proportional to the second measured distance 308.

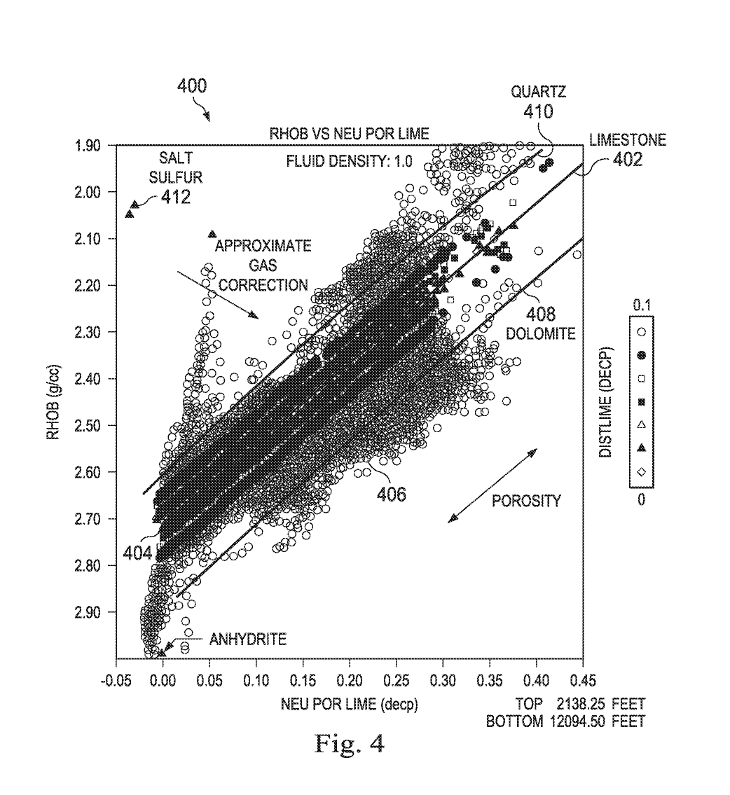

FIG. 4 is an example graph 400 showing samples of log data (e.g., bulk density “Rhob” and neutron porosity “Nphi” log data) being plotted against a limestone lithofacies response (e.g., limestone lithology function) 402 on a standard neutron-density crossplot (e.g., Rhob-Nphi crossplot), according to certain illustrative embodiments of the present disclosure. In FIG. 4, log data labeled as 404 indicates log data with closest proximity (nearness) to the limestone lithology function (lithology proximity model) 402, whereas other log data labeled as 406 indicates log data with a larger distance from the limestone lithology function (lithology proximity model) 402. In one or more embodiments, beside the limestone lithology proximity model illustrated in the example graph 400 in FIG. 4, one or more other lithology proximity models may be employed, such as a proximity model based on a dolomite lithofacies response 408 (dolomite lithology function), a proximity model based on a quartz lithofacies response 410 (quartz lithology function), a proximity model based on a salt sulfur lithology point 412, and the like. In accordance with embodiments of the present disclosure, for each bulk density “Rhob” and neutron porosity “Nphi” log data point shown in the illustrative Rhob-Nphi crossplot 400, a plurality of probability values may be obtained based on the proximity (nearness) of that Rhob-Nphi log data point to various lithology functions and/or lithology points (lithology proximity models).

For certain illustrative embodiments of the present disclosure, the resulting distance values (e.g., measured distances from each log value or datum point to lithology functions and/or lithology points on crossplots) may be passed to proximity probability functions for obtaining probability values, wherein each probability value indicates a probability that the log value (datum point) corresponds to a particular lithology (lithofacies) of a set of lithology types (set of lithofacies). In one or more embodiments, each proximity probability function may be designed such that to correspond to a particular lithology function (or lithology point). As discussed in more detail below, the probability values obtained from the proximity probability functions for each log value may be combined (e.g., based on a certain probabilistic analysis) to compute a final probability value indicating that the particular log value belongs, with a certain probability, to one specific lithofacies from the set of possible lithofacies.

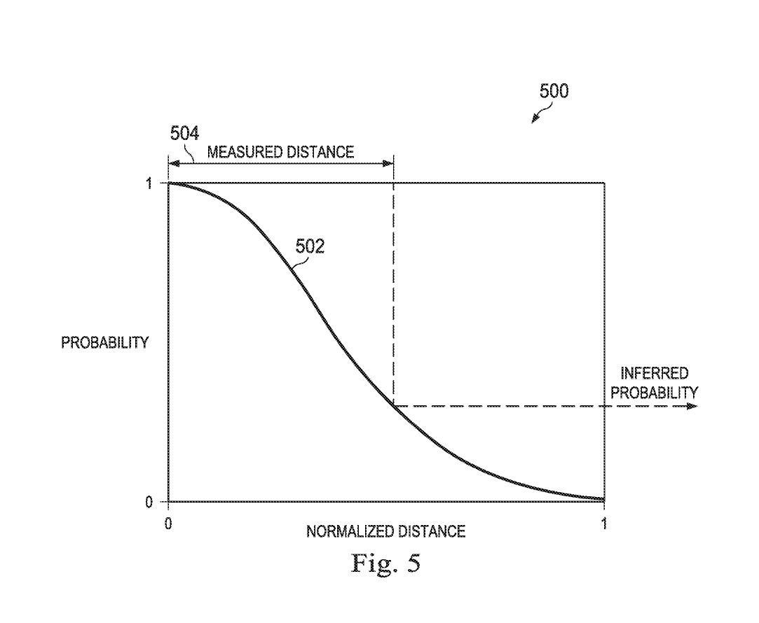

FIG. 5 illustrates a graph 500 of an illustrative proximity probability function 502 associated with a particular lithofacies response (lithology proximity model), according to certain illustrative embodiments of the present disclosure. As shown in FIG. 5, a measured distance 504 obtained by measuring proximity (nearness) of a log data (datum point) on a crossplot of log variables to a particular lithofacies response (e.g., lithology function or lithology point) may be passed to the proximity probability function 504 to obtain (infer) a probability value 506 that corresponds to the measured distance 502. In general, a proximity probability function (e.g., the illustrative proximity probability function 504) can be designed such that to provide larger inferred probabilities for smaller measured distances and smaller inferred probabilities for larger measured distances. In accordance with certain embodiments of the present disclosure, a proximity probability function (e.g., the illustrative proximity probability function 504) may differ for different lithology functions and lithology points (lithofacies responses) plotted on same or different crossplots of log variables. For certain other embodiments, a proximity probability function (e.g., the illustrative probability function 504) may differ for different crossplots of log data. In general, a proximity probability function (e.g., the illustrative proximity probability function 504) may differ for different lithology proximity models.

For certain illustrative embodiments of the present disclosure, measured distances of log data (datum points) from a particular lithofacies response (e.g., lithology function or lithology point) may be rescaled (or normalized) based on a pre-designed normalization function in order to adjust to numerical dynamics of a crossplot of log variables associated with the particular lithofacies response and/or to control sensitivity. Thus, the normalization function employed for rescaling (normalization) of measured distances of log data may be designed in accordance with a particular proximity model being utilized.

For certain illustrative embodiments of the present disclosure, the obtained results of the individual crossplot probabilities (e.g., probability values obtained for the same log value but for different lithofacies responses or different proximity models) may be combined to produce a final lithofacies probability analysis, i.e., a probability value indicating that the particular log value belongs, with a certain probability, to one specific lithofacies from a set of possible lithofacies. In one or more embodiments, the individual crossplot probabilities may be combined based on Bayesian analysis. In one or more other embodiments, the individual crossplot probabilities may be combined by applying probability weighting, i.e., different weights may be applied to different probabilities from different proximity models (e.g., different weights may be assigned to different lithofacies response). In one or more other embodiments, the individual crossplot probabilities may be combined to obtain a final lithofacies probability based on processing the individual crossplot probabilities by utilizing a neural network. Embodiments of the present disclosure may employ any number of crossplots of log data, from as few as a single crossplot to as many as a user can accurately define. The use of as many crossplots of log data as possible is desirable in order to improve accuracy and resolution of determining lithofacies probabilities and lithofacies subterranean earth model.

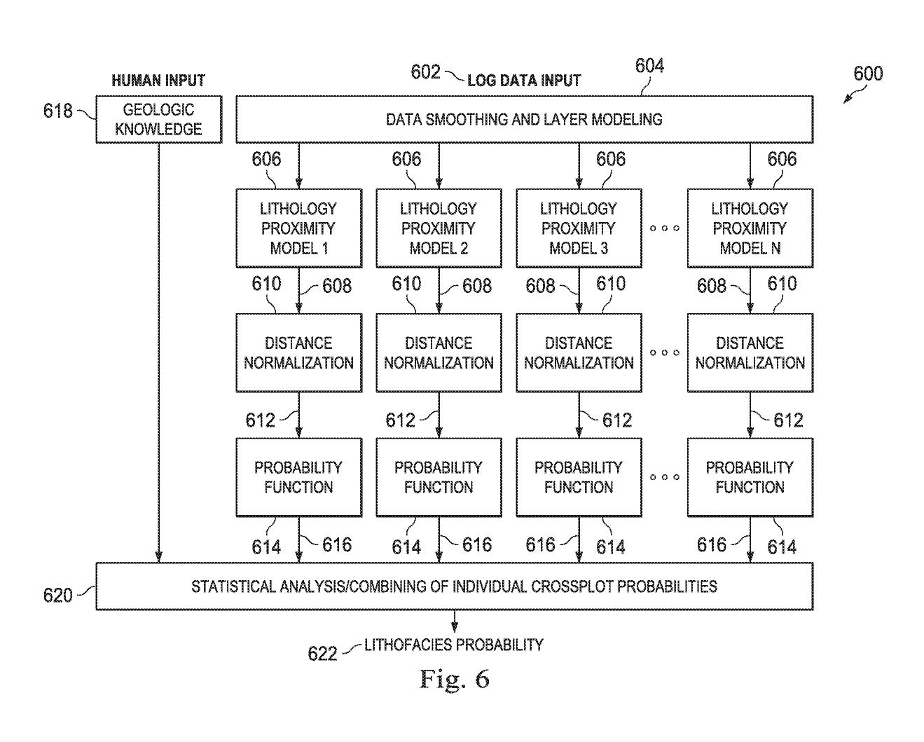

FIG. 6 illustrates a block diagram 600 of a lithofacies probability determination system, according to certain illustrative embodiments of the present disclosure. In one or more embodiments, log values (e.g., input log data 602) related to various depths of a formation penetrated by a wellbore and associated with different log variables may be initially gathered. The gathered input log data 602 may be then pre-processed by applying, for example, data smoothing and layer modeling, at block 604. The pre-processed log data for a specific formation depth associated with different log variables may be then passed into N (e.g., N 1) lithology proximity models 606, each lithology proximity models 606 being defined by a lithofacies response (e.g., lithology function or lithology point) on a crossplot of a subset of the log variables. Outputs 608 of the lithology proximity models 606 are distance measures of the log data for the specific formation depth relative to lithofacies responses (e.g., lithology functions and/or lithology points on crossplots) of the lithology proximity models 606. The distance measures 608 obtained by applying different lithology proximity models 606 may be then normalized (rescaled or calibrated) at distance normalization blocks 610, for example, by applying calibration unique for each lithology proximity model (lithofacies response). Following the normalization (rescaling or calibration), normalized distance measures 612 may be passed on to proximity probability functions 614 in order to map the normalized distance measures 612 to individual crossplot probabilities associated with different lithofacies responses and corresponding to the specific formation depth. For some embodiments, as discussed above, each proximity probability function 614 may correspond to a different lithology proximity model 606.

In one or more embodiments, the inferred individual crossplot probabilities 616 along with known geologic knowledge 618 (e.g., obtained from a user input) may be combined, at a statistical analysis block 620, in order to determine a final probability analysis, i.e., to obtain a final lithologic (lithofacies) probability 622 indicating that the specific formation depth associated with the log data input 602 belongs (with that probability) to a particular lithofacies of a set of possible lithofacies. In one or more embodiments, the individual crossplot probabilities 616 and the geologic knowledge 618 may be combined, at block 620, based on Bayesian analysis. In one or more other embodiments, the individual crossplot probabilities 616 and the geologic knowledge 618 may be combined by applying probability weighting at block 620, i.e., different weights may be applied to different probabilities from different proximity models 606 (e.g., different weights may be assigned to different lithofacies responses). In one or more other embodiments, the individual crossplot probabilities 616 and the geologic knowledge 618 may be combined by processing the probabilities 616 and the geologic knowledge 618 through a neural network (e.g., statistical analysis block 620 in FIG. 6 may correspond to a neural network). In one or more other embodiments, Bayesian analysis may be applied, at block 620, along with probability weighting and/or neural network processing.

In accordance with illustrative embodiments of the present disclosure, the method described in relation to the system block diagram 600 from FIG. 6 may be performed for a plurality of depths of the formation penetrated by the wellbore. Each output 622 of the lithofacies probability determination system 600 illustrated in FIG. 6 may correspond to a probability that each of the plurality of formation depths belongs to a particular lithofacies of a pre-defined set of possible lithofacies. The probabilistic outputs 622 of the lithofacies probability determination system 600 may form a lithofacies earth model for the formation penetrated by the wellbore.

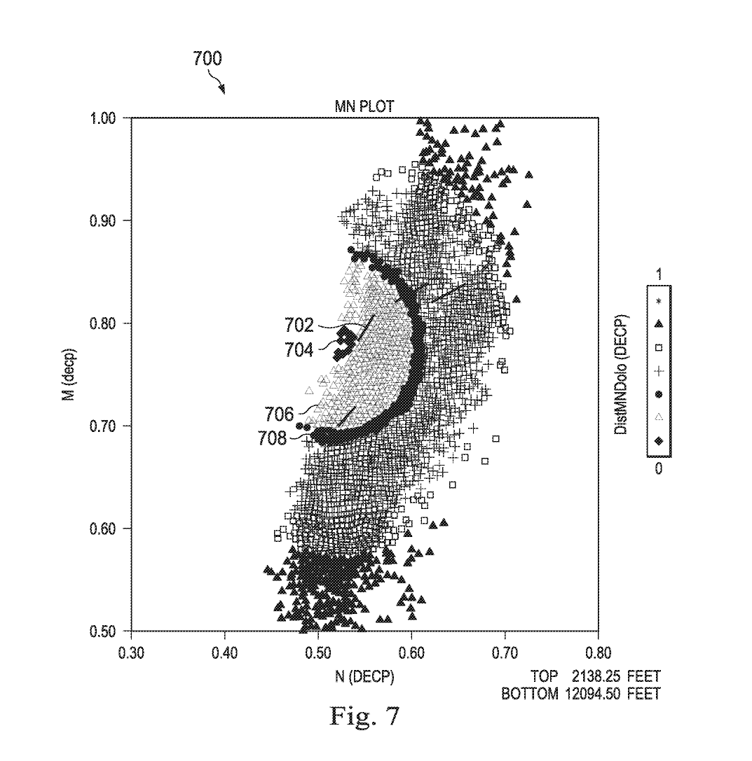

FIG. 7 illustrates an example graph 700 showing samples of log data being plotted against a dolomite lithofacies response (e.g., dolomite lithology function 702) on a litho-porosity (M-N) crossplot, according to certain embodiments of the present disclosure. Different shapes used to illustrate log data on the M-N crossplot in FIG. 7 indicate different proximity (nearness) of M-N log data to the dolomite lithofacies response 702. For example, as illustrated in FIG. 7, a shape 704 represents M-N log data having the closest proximities (nearness) to the dolomite lithofacies response 702; a shape 706 represents M-N log data having further distances to the dolomite lithofacies response 702 than the M-N log data 704; a shape 708 represents M-N log data having further distances to the dolomite lithofacies response 702 than the M-N log data 704 and 706, and so on. In one or more embodiments, the dolomite lithofacies response 702 on the litho-porosity M-N crossplot 700 may be associated with one of the lithology proximity models 606 of the lithofacies probability determination system 600 illustrated in FIG. 6. For some embodiments, proximity values for M-N log data related to the dolomite lithofacies response 702 on the litho-porosity M-N crossplot 700 may be processed (e.g., distance normalization 610 and proximity probability function 614 of the lithofacies probability determination system 600 illustrated in FIG. 6 may be applied) to obtain individual crossplot probabilities 616 for the proximity model defined by the dolomite lithofacies response 702 on the litho-porosity M-N crossplot 700 illustrated in FIG. 7. As discussed, an individual crossplot probability 616 may be larger as a proximity value for a specific M-N log value is smaller. In one or more embodiments, the individual crossplot probabilities obtained based on the lithology proximity model defined by the dolomite lithofacies response 702 on the litho-porosity M-N crossplot 700 illustrated in FIG. 7 may be combined with individual crossplot probabilities obtained based on one or more other lithology proximity models in order to determine final lithofacies probabilities and build the lithofacies earth model.

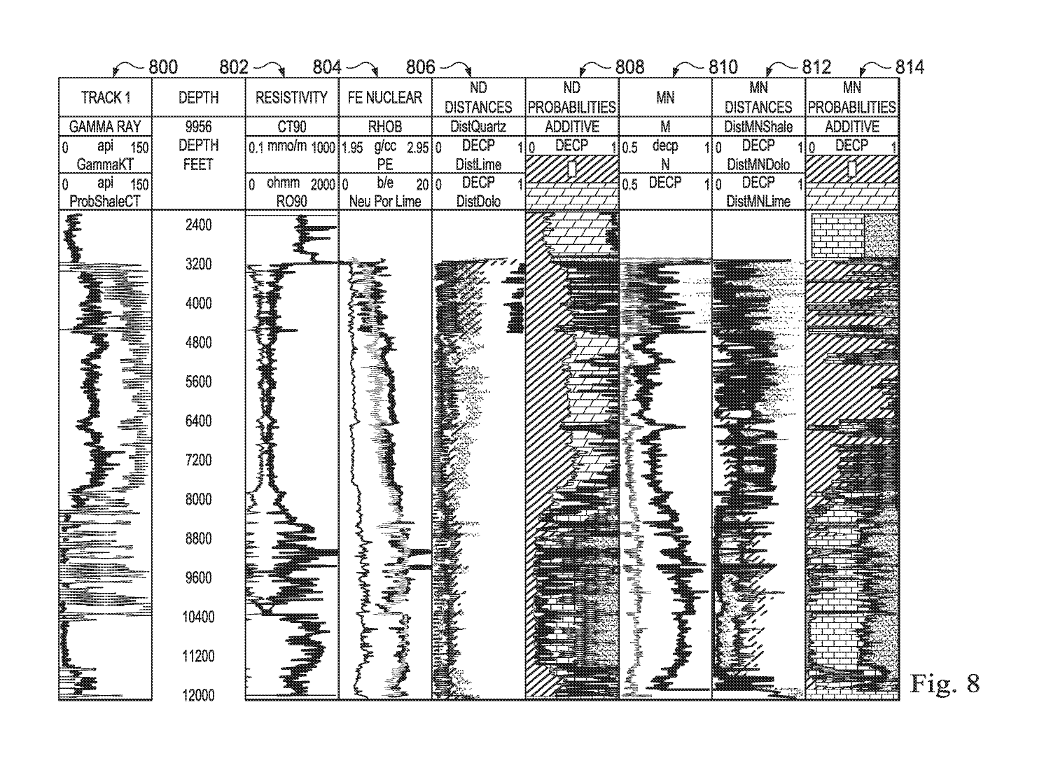

FIG. 8 is a graph showing examples of neutron-density crossplot probabilities and M-N crossplot probabilities as computed by the lithofacies probability determination system 600 illustrated in FIG. 6, according to certain illustrative embodiments of the present disclosure. As illustrated in graph 800 in FIG. 8, gamma ray log data (e.g., for potassium, uranium, and/or thorium) may be gathered for different formation depths. As further illustrated in graph 802 in FIG. 8, radial conductivity and radial resistivity log data may be gathered for different formation depths. As further illustrated in graph 804 in FIG. 8, bulk density “Rhob”, neutron porosity “Nphi” and photoelectric index “PE” log data may be obtained by a logging tool for a plurality of formation depths. The gathered log data illustrated in graphs 800, 802 and 804 in FIG. 8 may correspond to the log data 602 of the lithofacies probability determination system 600 illustrated in FIG. 6.

As illustrated in graph 806 in FIG. 8, distance measures on neutron-density “Rhob-Nphi” crossplot for different lithology proximity models (e.g., quartz lithology function, limestone lithology function and dolomite lithology point) can be determined. The distance measures illustrated in graph 806 may correspond to the normalized distance measures 612 obtained by different lithology proximity models 606 (e.g., quartz lithology function, limestone lithology function and dolomite lithology point) and normalization functions 610 of the lithofacies probability determination system 600 illustrated in FIG. 6. Neutron-density probabilities illustrated in graph 808 in FIG. 8 may be obtained by passing the distance measures illustrated in graph 806 to proximity probability functions (e.g., the proximity probability functions 614 of the lithofacies probability determination system 600 from FIG. 6) associated with different proximity models (e.g., quartz lithology function, limestone lithology function and dolomite lithology point). In one or more embodiments, the neutron-density probabilities illustrated in graph 808 may correspond to individual crossplot probabilities 616 of the lithofacies probability determination system 600 from FIG. 6.

As further illustrated in graph 810 in FIG. 8, litho-porosity M and N log data may be also gathered. As illustrated in graph 812 in FIG. 8, distance measures on litho-porosity “M-N” crossplot for different lithology proximity models (e.g., quartz lithology function, shale lithology function, limestone lithology function, dolomite lithology point, and the like) can be determined. The distance measures illustrated in graph 812 may correspond to the normalized distances 612 obtained by different lithology proximity models 606 (e.g., quartz lithology function, shale lithology function, limestone lithology function, and dolomite lithology point, and the like) and normalization functions 610 of the lithofacies probability determination system 600 from FIG. 6. Litho-porosity “M-N” probabilities illustrated in graph 814 in FIG. 8 may be obtained by passing the “M-N” distance measures illustrated in graph 812 to proximity probability functions (e.g., proximity probability functions 614 of the lithofacies probability determination system 600 from FIG. 6) associated with different proximity models (e.g., quartz lithology function, shale lithology function, limestone lithology function, and dolomite lithology point, and the like). In one or more embodiments, the litho-porosity “M-N” probabilities illustrated in graph 814 may correspond to individual crossplot probabilities 616 of the lithofacies probability determination system 600 from FIG. 6.

In accordance with certain embodiments of the present disclosure, the neutron-density probabilities illustrated in graph 808 in FIG. 8 and the litho-porosity “M-N” probabilities illustrated in graph 814 in FIG. 8 may be combined (e.g., along with known geological knowledge) based on a statistical analysis (e.g., performed at block 620 of the lithofacies probability determination system 600 illustrated in FIG. 6) to obtain final lithofacies probabilities related to the plurality of formation depths illustrated in FIG. 8 that represent a lithofacies earth model. For some embodiments, as discussed, the neutron-density probabilities illustrated in graph 808 and the litho-porosity “M-N” probabilities illustrated in graph 814 may be combined based on Bayesian analysis to obtain the final lithofacies probabilities for the plurality of formation depths. For some other embodiments, the neutron-density probabilities illustrated in graph 808 and the litho-porosity “M-N” probabilities illustrated in graph 814 may be combined by applying probability weighting, i.e., different weights may be applied to different probabilities from different proximity models (e.g., different weights may be assigned to different lithofacies responses) to obtain the final lithofacies probabilities for the plurality of formation depths. For some other embodiments, the neutron-density probabilities illustrated in graph 808 and the litho-porosity “M-N” probabilities illustrated in graph 814 may be combined by processing these individual crossplot probabilities (e.g., along with known geologic knowledge) through a neural network to obtain the final lithofacies probabilities for the plurality of formation depths. In one or more other embodiments, Bayesian analysis may be applied along with probability weighting and/or neural network processing for combining individual proximity models probabilities (e.g., the neutron-density probabilities illustrated in graph 808 and the litho-porosity “M-N” probabilities illustrated in graph 814) to obtain the final lithofacies probabilities for the plurality of formation depths.

Referring back to FIG. 6, illustrative embodiments of the present disclosure further relate to a method of preparing a library of lithology proximity models, distance normalization functions and proximity probability functions, which may be utilized, as discussed, by the lithofacies probability determination system 600 illustrated in FIG. 6. The library of lithology proximity models, distance normalization functions and proximity probability functions may be referred to as the Litho Space library. The method of preparing the Litho Space library may begin by preparing a list of primary lithology (lithofacies), such as, for example, limestone, dolomite, quartz, halite, coal, salt, anhydrite, shale (e.g., a plurality of shale layers), washouts, and any other lithofacies that maps to shapes or trends in the Litho Space. Principal physical properties of each lithology type (lithofacies) from the list may be then determined. For certain embodiments, log responses of each lithology type (lithofacies) from the list may be determined, which may be referred to as Data Space. For example, the log responses may comprise any of the following responses for different lithology types (lithofacies): Bulk density (Rhob), Neutron porosity (Nphi), Photoelectric Uranium (U) response, Gamma ray API (American Petroleum Institute) response, Acoustic compressional DT (delta time or slowness), Acoustic shear, Resistivity, NMR (Nuclear Magnetic Resonance) T2 response, NMR T1 response, Elemental yield from gamma ray emission from neutron absorption, Bulk modulus, Shear modulus, Young's modulus, Poisson's ratio, and the like.

In accordance with certain embodiments of the present disclosure, based on the log responses (e.g., Data Space), common lithofacies response equations (e.g., lithology functions and/or lithology points on crossplots of log variables) for lithology types (lithospecies) from the list may be gathered, wherein the common lithofacies response equations can be referred to as Litho Space subsets. The lithofacies response equations may be obtained for various crossplots of log variables, such as, for example, Rhob vs. Nphi, M vs. N, Rhoma vs. Uma (apparent density matrix vs. photoelectric absorption of matrix rock), Elemental yields, Gamma ray (GR) response, Uranium and Thorium response, RhoB vs. DTC (compressional slowness), shear modulus vs. bulk modulus, and the like. In one or more embodiments, each lithofacies response equation for a particular lithology type (lithofacies) from the list of lithofacies may correspond to a lithology proximity model 606 of the lithofacies probability determination system 600 illustrated in FIG. 6.

For certain embodiments, shale response functions may be determined, based on the previously determined log responses (e.g., Data Space) for the shale lithology type (shale lithofacies). In one or more embodiments, one-dimensional (1D) methods for determining shale response functions may comprise determining GR response, Resistivity response, Uranium (U) response, Thorium (Th) response, Thorium-Uranium ratios, and the like. In one or more other embodiments, two-dimensional (2D) methods for determining shale response functions may comprise determining GR vs. Resistivity response function, GR vs. Nphi response function and K (Potassium) vs. Uranium response function. In one or more other embodiments, three-dimensional (3D) methods for determining shale response functions may comprise determining Rhob vs. Nphi vs. GR response function, Rhob vs. Nphi vs. K/U ratio response function, Rhob vs. Nphi vs. Resistivity response function, M vs. N vs. GR response function, Rhoma vs. Uma vs. GR response function. The determined shale response functions (e.g., 1D, 2D, and 3D response functions) may correspond to lithology proximity models 606 of the lithofacies probability determination system 600 illustrated in FIG. 6.

In accordance with illustrative embodiments of the present disclosure, as discussed, a proximity probability function may be designed for each lithology proximity model (i.e., for each lithofacies response function on a crossplot of log variables). For some embodiments, the designed proximity probability functions may correspond to proximity probability functions 614 of the lithofacies probability determination system 600 illustrated in FIG. 6. In an embodiment, the proximity probability functions may be designed as Gaussian functions. For certain embodiments, as discussed, normalization calibration terms may be determined for each lithology proximity model (i.e., for each response equation/function related to each lithology type or lithofacies). In one or more embodiments, the determined normalization calibration terms may correspond to distance normalization 610 of the lithofacies probability determination system 600 illustrated in FIG. 6. For certain other embodiments, lookup tables may be utilized instead of lithofacies response equations, proximity probability functions and distance normalization. In this case, individual crossplot probabilities (e.g., probabilities 616 of the lithofacies probability determination system 600 illustrated in FIG. 6) may be calculated by mapping log data to a specific probability for each lithofacies in combination with used log variables (e.g., for each lithology function on a particular crossplot).

In accordance with embodiments of the present disclosure, the library of log responses, response equations/functions, proximity probability functions and normalization calibration for various lithology types (lithofacies) becomes the Litho Space library. For some embodiments, the output of probabilities from the Litho Space subsets (e.g., probabilities obtained based on various lithology proximity models or lithofacies response equations, such as probabilities 616 of the lithofacies probability determination system 600 from FIG. 6) may be combined using a certain probability handling method. In one or more embodiments, as discussed, the probabilities from the Litho Space subsets may be combined based on the Bayesian analysis. In one or more other embodiments, the probabilities from the Litho Space subsets may be combined by applying probability weighting, i.e., different weights may be applied to different probabilities from different Litho Space subsets (e.g., different weights may be assigned to different lithofacies response equations). In one or more other embodiments, the probabilities from the Litho Space subsets may be combined by processing these individual probabilities through a neural network.

For some embodiments of the present disclosure, petroleum well logging tools (e.g., wireline conveyed tools, drill pipe conveyed tools, and the like) may record variables that are members of the set of all real numbers. A subset of the real numbers called the Data Space can be created from the recorded variables. For certain embodiments, recorded in the Data Space may be points, trends or patterns created by the lithology of the formations encountered during logging operations. In one or more embodiments, the points, trends and patterns for each lithology of interest in the Data Space may be defined from theoretical, calibration or empirical methods. Furthermore, the points, trends or patterns of the lithologies of interest may be represented by either points or functions in the Data Space.

In accordance with embodiments of the present disclosure, the collection of all points and functions can be referred to as Litho Space. The collection of recorded variables makes up a set of the real numbers that can be referred to as Variable Space. For some embodiments, as discussed, the probability of any point of Variable Space also being a member of one of the lithologies in Litho Space is a function of the distance from that point to the points or functions recorded in Litho Space. In one or more embodiments, Variable Space can be created from any number of log variables. Any variable that responds to variations in lithology can be used to define Litho Space and Variable Space.

In one or more embodiments, if a number of variables that map to a particular lithology response in Litho Space is greater, then it is more probable that the variables accurately reflect the lithology of the formation from which they were taken. For some embodiments, as discussed, Litho Space can be divided into N subspaces (e.g., Litho Space subsets), each represented by a subset of variables to test for lithology. The final Litho Space can be defined by the probabilities of the Sub Spaces tested, through, for example, weighting probability, Bayesian analysis and/or neural network processing. In one or more embodiments, prior knowledge, core measures and any other external knowledge can be treated as Litho subspaces and used to obtain the final Litho Space (e.g., final lithofacies probabilities).

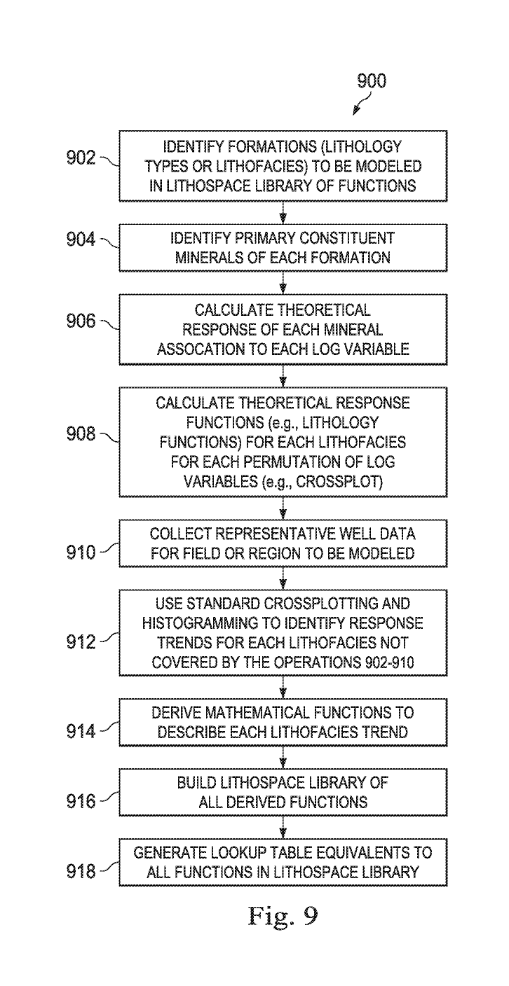

FIG. 9 is a flow chart 900 of a method for preparing a library of primary lithofacies response functions (e.g., Litho Space library), according to certain illustrative embodiments of the present disclosure. The method begins at 902 by identifying formations (e.g., lithology types or lithofacies) to be modeled in the Litho Space library of functions. At 904, primary constituent minerals of each formation may be identified. At 906, where possible, theoretical response of each mineral association to each log variable may be calculated. At 908, theoretical response functions (e.g., lithofacies responses) for each lithofacies for each permutation of log variables (e.g., crossplot) may be calculated. At 910, representative well data (e.g., Data Space) may be collected for field or region to be modeled. At 912, standard crossplotting and histogramming may be used to identify response trends for each lithofacies not covered by the operations 902-910. At 914, mathematical functions may be derived to describe each lithofacies trend. At 916, the Litho Space library of all derived functions (e.g., lithofacies responses) may be built. At 918, lookup table equivalents to all functions (e.g., lithofacies responses) in the Litho Space library may be generated.

Referring back to FIG. 6, for certain embodiments of the present disclosure, the Litho Space model (e.g., lithology proximity models) may be utilized for practical estimation of lithofacies. First, log data may be collected (e.g., log data 602 of the lithofacies probability determination system 600 from FIG. 6), and standard quality assessment and editing of log data may be employed (e.g., data smoothing and layer modeling 604 of the lithofacies probability determination system 600 from FIG. 6). In one or more embodiments, shale assessment plots may be first made based upon the log data. Also, as needed, shale function models of the Litho Space may be refined. Then, Shale Space probabilities (e.g., probabilities related to shale lithology types or shale lithofacies) may be computed based on the shale assessment plots and shale function models.

In one or more embodiments, the Shale Space probabilities and log data may be submitted to the primary Litho Space model (e.g., the prepared lithology proximity models, such as the lithology proximity models 606 of the lithofacies probability determination system 600 from FIG. 6) to compute Litho Space probabilities (e.g., probabilities 616 of the lithofacies probability determination system 600 from FIG. 6). The Litho Space probabilities may be reviewed for possible refinement of response functions (e.g., lithology proximity models). Additional inputs (e.g., beside Shale Space probabilities and log data) for the Litho Space model may be obtained, such as assigning formation tops, adding prior geologic knowledge (e.g., cores, mud logs, core lab reports, and the like). The additional inputs along with the Shale Space probabilities and log data may be again submitted to the Litho Space model in order to improve Litho Space probabilities (e.g., probabilities 616 of the lithofacies probability determination system 600 from FIG. 6). This process may be repeated as new information becomes available. The Litho Space probabilities (e.g., probabilities 616 of the lithofacies probability determination system 600 from FIG. 6) obtained by applying various lithofacies response functions (e.g., the lithology proximity models 606 illustrated in FIG. 6) may be combined to obtain final probability output (e.g., final lithofacies probabilities) and a lithofacies earth model. For some embodiments, as discussed, the Litho Space probabilities may be combined based on Bayesian analysis, probability weighting and/or by neural network processing.

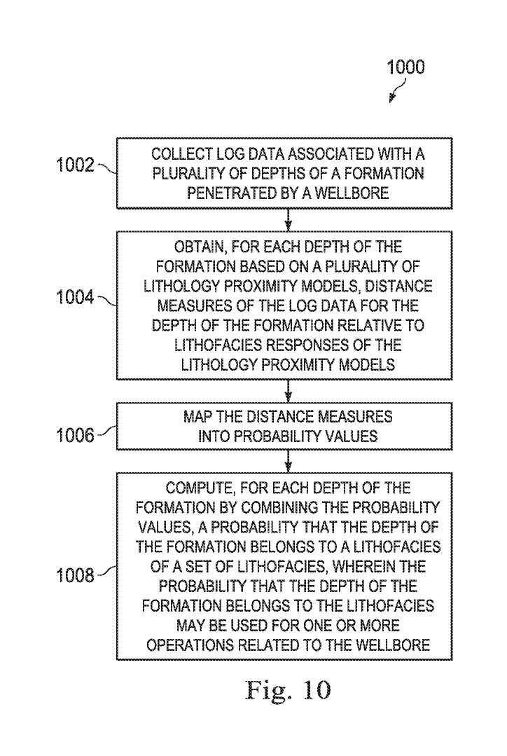

Discussion of an illustrative method of the present disclosure will now be made with reference to FIG. 10, which is a flow chart 1000 of a method for computing lithofacies probabilities using lithology proximity models (crossplot proximity) and statistical analysis (e.g., Bayesian analysis, probability weighting and/or neural network processing), according to certain illustrative embodiments of the present disclosure. The method begins at 1002 by collecting log data (e.g., log data 602 of the lithofacies probability determination system 600 from FIG. 6) associated with a plurality of depths of a formation penetrated by a wellbore. At 1004, for each depth of the formation based on a plurality of lithology proximity models (e.g., the lithology proximity models 606 of the lithofacies probability determination system 600 from FIG. 6), distance measures (e.g., the distance measures 608 in FIG. 6) of the log data for the depth of the formation may be obtained relative to lithofacies responses (e.g., lithology functions and/or lithology points) of the lithology proximity models. At 1006, the distance measures may be mapped (e.g., by applying the proximity probability functions 614 of the lithofacies probability determination system 600 from FIG. 6) into probability values (e.g., individual crossplot probabilities 616 in FIG. 6). At 1008, a probability (e.g., the lithofacies probability 622 in FIG. 6) that the depth of the formation belongs to a lithofacies of a set of lithofacies may be computed, for each depth of the formation, by combining the probability values. In one or more embodiments, the probability that the depth of the formation belongs to the lithofacies may be used for one or more operations related to the wellbore.

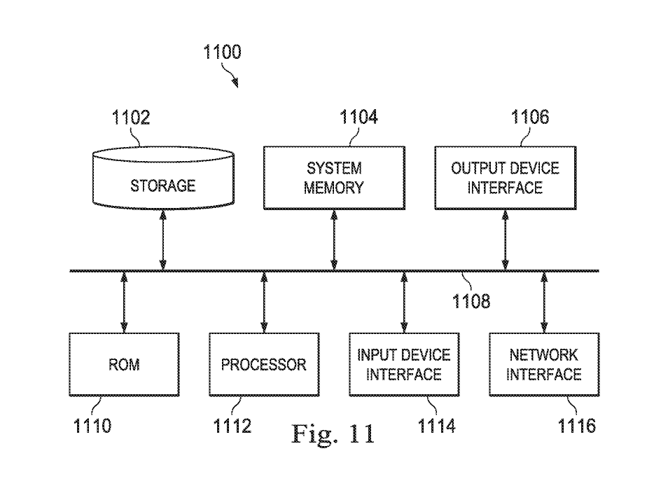

FIG. 11 is a block diagram of an illustrative computing system 1100 in which embodiments of the present disclosure may be implemented adapted for computing lithofacies probabilities using lithology proximity models (e.g., crossplot proximity) and probabilistic analysis, such as combining individual crossplot probabilities into a final lithofacies probability based on Bayesian analysis, probability weighting, and/or neural network processing. For example, some of the operations of method 900 of FIG. 9 and the operations of method 1000 of FIG. 10, as described above, may be implemented using the computing system 1100. The computing system 1100 can be a computer (e.g., computer 50 of the LWD environment illustrated in FIG. 1), phone, personal digital assistant (PDA), or any other type of electronic device. Such an electronic device includes various types of computer readable media and interfaces for various other types of computer readable media. As shown in FIG. 11, the computing system 1100 includes a permanent storage device 1102, a system memory 1104, an output device interface 1106, a system communications bus 1108, a read-only memory (ROM) 1110, processing unit(s) 1112, an input device interface 1114, and a network interface 1116.

In one or more embodiments, computing system 1100 may comprise the lithofacies probability determination system 600 illustrated in FIG. 6. For certain embodiments, computing system 1100 configured for determining lithofacies probabilities may be an integral part of LWD logging tool 24 of the LWD environment illustrated in FIG. 1 and/or of wireline logging tool 34 illustrated in FIG. 2. The determined lithofacies probabilities may be communicated as an uplink signal from LWD logging tool 24 (or wireline logging tool 34) to data acquisition module 36 and data processing system 50 at the surface. Output device 56 interfaced with data processing system 50 may display the signal (e.g., lithofacies probabilities or lithofacies earth model) to a user. For certain other embodiments, computing system 1100 configured for determining lithofacies probabilities may be computer 50 of the LWD environment illustrated in FIG. 1. In this case, log data acquired by LWD logging tool 24 may be communicated as an uplink signal from LWD logging tool 24 to data acquisition module 36. Log data may be then received by data processing system (computer) 50, which may demodulate data and perform operations of the lithofacies probability determination system 600 illustrated in FIG. 6 to determine lithofacies probabilities (and corresponding lithofacies earth model). Output device 56 interfaced with data processing system (computer) 50 may display the signal (e.g., the lithofacies earth model in accordance with lithofacies probabilities) to a user, which may utilize the displayed signal for various wellbore-related operations, such as directional drilling, logging-while-drilling, and the like.

The bus 1108 collectively represents all system, peripheral, and chipset buses that communicatively connect the numerous internal devices of the computing system 1100. For instance, the bus 1108 communicatively connects the processing unit(s) 1112 with the ROM 1110, the system memory 1104, and the permanent storage device 1102.

From these various memory units, the processing unit(s) 1112 retrieves instructions to execute and data to process in order to execute the processes of the subject disclosure. The processing unit(s) can be a single processor or a multi-core processor in different implementations.

The ROM 1110 stores static data and instructions that are needed by the processing unit(s) 1112 and other modules of the computing system 1100. The permanent storage device 1102, on the other hand, is a read-and-write memory device. This device is a non-volatile memory unit that stores instructions and data even when the computing system 1100 is off. Some implementations of the subject disclosure use a mass-storage device (such as a magnetic or optical disk and its corresponding disk drive) as the permanent storage device 1102.

Other implementations use a removable storage device (such as a floppy disk, flash drive, and its corresponding disk drive) as the permanent storage device 1102. Like the permanent storage device 1102, the system memory 1104 is a read-and-write memory device. However, unlike the storage device 1102, the system memory 1104 is a volatile read-and-write memory, such a random access memory. The system memory 1104 stores some of the instructions and data that the processor needs at runtime. In some implementations, the processes of the subject disclosure are stored in the system memory 1104, the permanent storage device 1102, and/or the ROM 1110. For example, the various memory units include instructions for computer aided pipe string design based on existing string designs in accordance with some implementations. From these various memory units, the processing unit(s) 1112 retrieves instructions to execute and data to process in order to execute the processes of some implementations.

The bus 1108 also connects to the input and output device interfaces 1114 and 1106. The input device interface 1114 enables the user to communicate information and select commands to the computing system 1100. Input devices used with the input device interface 1114 include, for example, alphanumeric, QWERTY, or T9 keyboards, microphones, and pointing devices (also called “cursor control devices”). The output device interfaces 1106 enables, for example, the display of images generated by the computing system 1100. Output devices used with the output device interface 1106 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 11, the bus 1108 also couples the computing system 1100 to a public or private network (not shown) or combination of networks through a network interface 1116. Such a network may include, for example, a local area network (“LAN”), such as an Intranet, or a wide area network (“WAN”), such as the Internet. Any or all components of the computing system 1100 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, some of the operations of method 900 of FIG. 9 and the operations of method 1000 of FIG. 10, as described above, may be implemented using the computing system 1100 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs implemented on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of operations in the processes disclosed is an illustration of exemplary approaches. Based upon design preferences, it is understood that the specific order or hierarchy of operations in the processes may be rearranged, or that all illustrated operations be performed. Some of the operations may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the illustrative methods described herein may be implemented by a system including processing circuitry or a computer program product including instructions which, when executed by at least one processor, causes the processor to perform any of the methods described herein.

A computer-implemented method for computing lithofacies probabilities has been described in the present disclosure and may generally include: collecting log data associated with a plurality of depths of a formation penetrated by a wellbore; obtaining, for each depth of the formation based on a plurality of lithology proximity models, distance measures of the log data for the depth of the formation relative to lithofacies responses of the lithology proximity models; mapping the distance measures into probability values; and computing, for each depth of the formation by combining the probability values, a probability that the depth of the formation belongs to a lithofacies of a set of lithofacies, wherein the probability that the depth of the formation belongs to the lithofacies may be used for one or more operations related to the wellbore. Further, a computer-readable storage medium having instructions stored therein, which when executed by a computer cause the computer to perform a plurality of functions, including functions to: collect log data associated with a plurality of depths of a formation penetrated by a wellbore; obtain, for each depth of the formation based on a plurality of lithology proximity models, distance measures of the log data for the depth of the formation relative to lithofacies responses of the lithology proximity models; map the distance measures into probability values; and compute, for each depth of the formation by combining the probability values, a probability that the depth of the formation belongs to a lithofacies of a set of lithofacies, wherein the probability that the depth of the formation belongs to the lithofacies may be used for one or more operations related to the wellbore.

For the foregoing embodiments, the method or functions may include any one of the following operations, alone or in combination with each other: Performing smoothing and layer modeling of the log data; Normalizing the distance measures prior to mapping the distance measures into the probability values; Mapping the distance measures into the probability values is based on proximity probability functions, each proximity probability function corresponds to one of the lithology proximity models; Computing the probability comprises combining a geologic knowledge and the probability values based on at least one of: Bayesian analysis of the probability values, weighting of the probability values, or processing of the probability values using a neural network; Preparing a library of the lithology proximity models; Preparing the library comprises: preparing the set of lithofacies, determining physical properties of each lithofacies from the set, determining log responses of each lithofacies from the set associated with a plurality of variables, and obtaining, based at least in part on the physical properties and the log responses, the lithofacies responses for each lithofacies from the set for different subsets of the plurality of variables; Designing a proximity probability function for each lithofacies response for a subset of the plurality of variables; Determining normalization calibrations for each lithofacies response for a subset of the plurality of variables.

The log data are associated with a plurality of log variables; Each lithology proximity model is related to a subset of the log variables; Each lithofacies response is represented by a lithology function or a lithology point for a subset of the log variables; The one or more operations related to the wellbore comprise adjusting drilling the wellbore based at least in part on the probability that the depth of the formation belongs to the lithofacies of the set of lithofacies.

Likewise, a system for computing lithofacies probabilities has been described and include at least one processor and a memory coupled to the processor having instructions stored therein, which when executed by the processor, cause the processor to perform functions, including functions to: collect log data associated with a plurality of depths of a formation penetrated by a wellbore; obtain, for each depth of the formation based on a plurality of lithology proximity models, distance measures of the log data for the depth of the formation relative to lithofacies responses of the lithology proximity models; map the distance measures into probability values; and compute, for each depth of the formation by combining the probability values, a probability that the depth of the formation belongs to a lithofacies of a set of lithofacies, wherein the probability that the depth of the formation belongs to the lithofacies may be used for one or more operations related to the wellbore.

For any of the foregoing embodiments, the system may include any one of the following elements, alone or in combination with each other: the functions performed by the processor include functions to perform smoothing and layer modeling of the log data; the functions performed by the processor include functions to normalize the distance measures prior to mapping the distance measures into the probability values; the functions for computing the probability performed by the processor include functions to combine a geologic knowledge and the probability values based on at least one of: Bayesian analysis of the probability values, weighting of the probability values, or processing of the probability values by using a neural network; the functions performed by the processor include functions to prepare a library of the lithology proximity models; the functions for preparing the library of the lithology proximity models performed by the processor include functions to: prepare the set of lithofacies, determine physical properties of each lithofacies from the set, determine log responses of each lithofacies from the set associated with a plurality of variables, and obtain, based at least in part on the physical properties and the log responses, the lithofacies responses for each lithofacies from the set for different subsets of the plurality of variables; the functions performed by the processor include functions to design a proximity probability function for each lithofacies response for a subset of the plurality of variables; the functions performed by the processor include functions to determine normalization calibrations for each lithofacies responses for a subset of the plurality of variables.

Embodiments of the present disclosure are particularly useful for building a subsurface description of formation lithotypes from patterns appearing in cross-correlations of various wireline measured data. The resulting subsurface (earth) model can be tied to known formation depths to produce an accurate lithofacies map of formations encountered in the well.

In accordance with certain embodiments of the present disclosure, probability functions are developed herein to equate distances from mineral response overlays to probabilities. Further, weighting functions can be developed for, for example, neutron porosity, bulk density, PE, gamma ray, bulk modulus, shear modulus, and M and N log data. The method presented in this disclosure for determining lithofacies probabilities is conducted using standard neutron-density-PE crossplots, M-N crossplots, bulk modulus-shear modulus crossplots and various gamma ray and resistivity shale functions. Various complex lithology and shaly-sand data sets are analyzed and compared to known lithology.

Advantages of the present disclosure include, but are not limited to, providing data technicians, log analysts and petrophysicists with a working formation lithotype model, assisting in interpretation model and parameter selection. The method presented in this disclosure for determining lithofacies probabilities may aid in reservoir mapping by assisting users in identifying formation tops. The method presented herein can provide client geological professionals with a tie between well logs and sub-surface geological mapping. The presented method can also provide answers from a minimum amount of data, but results can be continually improved by the addition of petrophysical data.

The method presented in this disclosure allows for the input of prior information of the formation and formation tops, in the form of historical knowledge or client supplied information. Embodiments of the present disclosure may provide inexperienced log analysts tools to make reasoned parameter selection for current software products, while allowing and encouraging client involvement in the product solution process. The method presented herein can be used with LWD, wireline and/or customer supplied data, while allowing for the input of prior knowledge of geologic setting, maturation, diagenetic processes, and the like. The method presented in this disclosure can be used with any level of prior software product experience.

Embodiments of the present disclosure can be used during logging-while-drilling operations to obtain the lithofacies probabilities utilized for tracking the process of drilling and arrival at the target formation, as well as for identifying sources of the cuttings collected for mud logging operations. Embodiments of the present disclosure can be also used during directional-drilling operations to help steer a drill bit based on the obtained lithofacies probabilities. Embodiments of the present disclosure can be further used during wireline operations to help identify formation names and tops, as well as to assist well-site geologists in tying formation tops with log responses.

The lithofacies probabilities and the lithofacies earth model obtained in accordance with embodiments of the present disclosure can be used to assist log analysts and petrophysicists in formation identification. Furthermore, the results obtained in accordance with certain embodiments of the present disclosure can be used to assist log analysts and petrophysicists in building a rock model of the logged interval. In addition, embodiments of the present disclosure provide results that can be used to assist log analysts and petrophsicists in selecting parameters for reservoir evaluation and reserves calculation. Embodiments of the present disclosure can be also used to evaluate quality of log data.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

While specific details about the above embodiments have been described, the above hardware and software descriptions are intended merely as example embodiments and are not intended to limit the structure or implementation of the disclosed embodiments. For instance, although many other internal components of computer system 1100 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the Figures illustrate the architecture, functionality, and operation of possible implementations of systems, methods and computer program products according to various embodiments of the present disclosure. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

What is claimed is:

1. A computer-implemented method for computing lithofacies probabilities, the method comprising:
collecting log data associated with a plurality of depths of a formation penetrated by a wellbore;
obtaining, for each depth of the formation based on a plurality of lithology proximity models, distance measures of the log data for the depth of the formation relative to lithofacies responses of the lithology proximity models;
mapping the distance measures into probability values; and
computing, for each depth of the formation by combining the probability values, a probability that the depth of the formation belongs to a lithofacies of a set of lithofacies,
wherein the probability that the depth of the formation belongs to the lithofacies may be used for one or more operations related to the wellbore.

2. The method of claim 1, wherein:
the log data are associated with a plurality of log variables, and
each lithology proximity model is related to a subset of the log variables.

3. The method of claim 1, wherein each lithofacies response is represented by a lithology function or a lithology point for a subset of the log variables.

4. The method of claim 1, further comprising performing smoothing and layer modeling of the log data.

5. The method of claim 1, further comprising normalizing the distance measures prior to mapping the distance measures into the probability values.

6. The method of claim 1, wherein mapping the distance measures into the probability values is based on proximity probability functions, each proximity probability function corresponds to one of the lithology proximity models.

7. The method of claim 1, wherein computing the probability comprises combining a geologic knowledge and the probability values based on at least one of: Bayesian analysis of the probability values, weighting of the probability values, or processing of the probability values using a neural network.

8. The method of claim 1, further comprising preparing a library of the lithology proximity models.

9. The method of claim 8, wherein preparing the library comprises:
preparing the set of lithofacies;
determining physical properties of each lithofacies from the set;
determining log responses of each lithofacies from the set associated with a plurality of variables; and
obtaining, based at least in part on the physical properties and the log responses, the lithofacies responses for each lithofacies from the set for different subsets of the plurality of variables.

10. The method of claim 9, further comprising:
designing a proximity probability function for each lithofacies response for a subset of the plurality of variables; and
determining normalization calibrations for each lithofacies response for a subset of the plurality of variables.

11. The method of claim 1, wherein the one or more operations related to the wellbore comprise adjusting drilling the wellbore based at least in part on the probability that the depth of the formation belongs to the lithofacies of the set of lithofacies.

12. A system for computing lithofacies probabilities, the system comprising:
at least one processor; and
a memory coupled to the processor having instructions stored therein, which when executed by the processor, cause the processor to perform functions, including functions to:
collect log data associated with a plurality of depths of a formation penetrated by a wellbore;
obtain, for each depth of the formation based on a plurality of lithology proximity models, distance measures of the log data for the depth of the formation relative to lithofacies responses of the lithology proximity models;
map the distance measures into probability values; and
compute, for each depth of the formation by combining the probability values, a probability that the depth of the formation belongs to a lithofacies of a set of lithofacies,
wherein the probability that the depth of the formation belongs to the lithofacies may be used for one or more operations related to the wellbore.

13. The system of claim 12, wherein:
the log data are associated with a plurality of log variables, and
each lithology proximity model is related to a subset of the log variables.

14. The system of claim 12, wherein each lithofacies response is represented by a lithology function or a lithology point for a subset of the log variables.

15. The system of claim 12, wherein the functions performed by the processor include functions to perform smoothing and layer modeling of the log data.

16. The system of claim 12, wherein the functions performed by the processor include functions to normalize the distance measures prior to mapping the distance measures into the probability values.

17. The system of claim 12, wherein mapping the distance measures into the probability values is based on proximity probability functions, each proximity probability function corresponds to one of the lithology proximity models.

18. The system of claim 12, wherein the functions for computing the probability performed by the processor include functions to combine a geologic knowledge and the probability values based on at least one of: Bayesian analysis of the probability values, weighting of the probability values, or processing of the probability values by using a neural network.

19. The system of claim 12, wherein the functions performed by the processor include functions to prepare a library of the lithology proximity models.

20. The system of claim 19, the functions for preparing the library of the lithology proximity models performed by the processor include functions to:
prepare the set of lithofacies;
determine physical properties of each lithofacies from the set;
determine log responses of each lithofacies from the set associated with a plurality of variables; and
obtain, based at least in part on the physical properties and the log responses, the lithofacies responses for each lithofacies from the set for different subsets of the plurality of variables.

21. The system of claim 20, wherein the functions performed by the processor include functions to:
design a proximity probability function for each lithofacies response for a subset of the plurality of variables; and
determine normalization calibrations for each lithofacies responses for a subset of the plurality of variables.

22. The system of claim 12, wherein the one or more operations related to the wellbore comprise adjusting drilling the wellbore based at least in part on the probability that the depth of the formation belongs to the lithofacies of the set of lithofacies.

23. A computer-readable storage medium having instructions stored therein, which when executed by a computer cause the computer to perform a plurality of functions, including functions to:
collect log data associated with a plurality of depths of a formation penetrated by a wellbore;
obtain, for each depth of the formation based on a plurality of lithology proximity models, distance measures of the log data for the depth of the formation relative to lithofacies responses of the lithology proximity models;
map the distance measures into probability values; and
compute, for each depth of the formation by combining the probability values, a probability that the depth of the formation belongs to a lithofacies of a set of lithofacies,
wherein the probability that the depth of the formation belongs to the lithofacies may be used for one or more operations related to the wellbore.

24. The computer-readable storage medium of claim 23, wherein the instructions further perform functions to combine a geologic knowledge and the probability values based on at least one of Bayesian analysis of the probability values, weighting of the probability values, or processing of the probability values by using a neural network to compute the probability that the depth of the formation belongs to the lithofacies of the set of lithofacies.
